(19) United States
(12) Patent Application Publication
(10) Pub. No.: US 2015/0303536 A1
(43) Pub. Date: Oct. 22, 2015

(54) BATTERY THERMAL MANAGEMENT SYSTEM

(71) Applicant: FORD GLOBAL TECHNOLOGIES, LLC, DEARBORN, MI (US)

(72) Inventors: BHASKARA BODDAKAYALA, CANTON, MI (US); BRUCE C. BLAKEMORE, PLYMOUTH, MI (US); SHIGUANG ZHOU, ANN ARBOR, MI (US); RAYMOND C. SICIAK, ANN ARBOR, MI (US)

(73) Assignee: FORD GLOBAL TECHNOLOGIES, LLC, DEARBORN, MI (US)

(21) Appl. No.: 14/258,221

(22) Filed: Apr. 22, 2014

(51) Int. Cl. H01M 10/6552

(52) U.S. Cl. CPC H01M 10/6552; H01M 10/613; H01M 10/625; H01M 10/63; H01M 10/6551; H01M 2220/20

(57) ABSTRACT

A battery is assembled from cells arranged along an axis. The cells have end faces parallel to the line and first and second sides perpendicular to the faces. The first side of a first cell contacts the second side of a second cell. A sealed piping circuit includes a first heat exchanger in contact with, and spanning, the end faces and a second heat exchanger in fluid communication with the first heat exchanger for heat transfer between the heat exchangers.

### BACKGROUND OF INVENTION

The present invention relates to automotive batteries and in particular to a system for managing a thermal state of the batteries.

A hybrid electric powertrain of an automotive vehicle may include a battery comprised of a plurality of cells. Typically, the battery is maintained within an optimum temperature range for efficient operation. For example, the battery may be maintained within the temperature range by locating the battery contiguous with a passenger compartment of the vehicle.

However, locating the battery contiguous with the passenger compartment may reduce usable vehicle space for vehicle occupants.

### SUMMARY OF INVENTION

An embodiment contemplates a battery thermal system. A battery has cells arranged along an axis and having end faces parallel to the axis. First and second heat exchangers are in a sealed piping circuit. The first heat exchanger is in contact with, and spans, the end faces. The second heat exchanger, spaced from the battery, is in fluid communication with the first heat exchanger for transferring heat between the heat exchangers.

Another embodiment contemplates a battery thermal system. A battery includes cells having first and second faces perpendicular to cell end faces, the first face of a first cell contacting a second face of a second cell. First and second heat exchangers are in a sealed piping circuit. The first heat exchanger spans one end face of each cell. The second heat exchanger, spaced from the battery, is in fluid communication with the first heat exchanger for transferring heat between the heat exchangers.

Another embodiment contemplates a method of thermally managing a vehicle battery. A fluid is circulated through a first heat exchanger spanning one end face of each cell of a battery, each cell having first and second faces perpendicular to the end faces and the first face of a first cell contacting the second face of an adjacent cell. Heat is exchanged between the first heat exchanger and the cells. The fluid is circulated through a circuit to transfer heat between the first and a second heat exchanger.

An advantage of an embodiment is the battery may be maintained within an optimum temperature range without having to locate the battery contiguous with a passenger compartment of a vehicle.

### BRIEF DESCRIPTION OF DRAWINGS

FIG. 1 is a schematic perspective view of a battery thermal management system.

FIG. 2 is a schematic perspective view of a portion of the battery thermal management system in FIG. 1.

### DETAILED DESCRIPTION

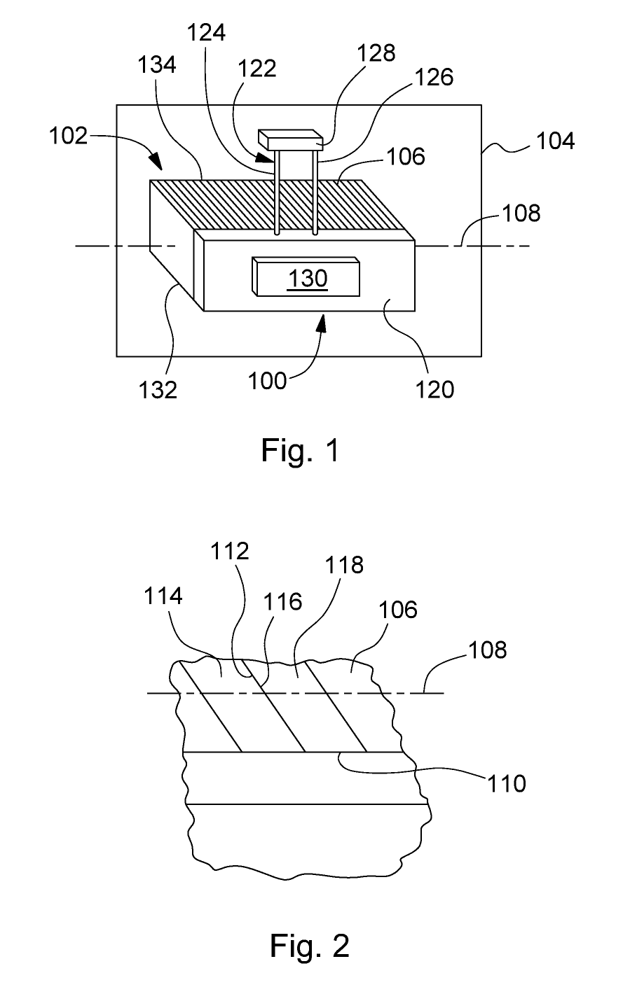

FIGS. 1 and 2 schematically illustrate a battery thermal management system 100 for a battery 102 in an automotive vehicle 104.

The battery 102 is comprised of a plurality of individual cells 106 arranged along an axis 108. End faces 110 are parallel to the axis 108. A first side face 112 of a first cell 114 contacts a second side face 116 of an adjacent second cell 118. The first and second side faces 112 and 116, respectively, are perpendicular to the end faces 110. As used herein, “sideface” is a face of a cell that faces and is adjacent to (and may be in contact with) a “side face” of an adjacent cell. The “end faces,” then, do not face a side of an adjacent cell in this particular assembly of adjacent cells.

A first heat exchanger 120 is in contact with, and spans, the end faces 110. Piping 122 places the first heat exchanger 120 in fluid communication with a second heat exchanger 128 for transferring heat between the first and second heat exchangers 120 and 128, respectively. The piping 122 may comprise multiple lines. For example, the piping 122 may comprise separate vapor and condensate lines 124 and 126, respectively. Alternatively, the piping 122 may comprise a single line.

The piping 122 and the first and second heat exchangers 120 and 128, respectively, comprise a fluid circuit. A fluid is circulated, preferably under pressure, through the fluid circuit. The fluid may be a suitable heat transfer medium known to those skilled in the art. For example, the fluid may be water, liquid ammonia, a phase change refrigerant, or a coolant. The fluid used may be selected, in part, on the basis of being a poor electrical conductor or rapidly evaporative. The first and second heat exchangers 120 and 128, respectively, are of a suitable design known to one skilled in the art. For example, the first heat exchanger 120 may be a sealed plate having passages through which the fluid is circulated and the second heat exchanger 128 may be cooling fins that use ambient air flow between the fins to cool the fluid circulating through tubes connected to the fins. The second heat exchanger 128 may be a condenser when the fluid is the refrigerant.

During cooling operation, the fluid absorbs heat from the cells 106 through the first heat exchanger 120 and expels heat through the second heat exchanger 128. For example, the fluid may expel heat through the second heat exchanger 128 to air flowing through it to the surrounding atmosphere. During warming operation, the fluid transfers heat from the second heat exchanger 128 to the first heat exchanger 120 which, in turn, raises a temperature of the cells 106. Heat may be supplied to the first heat exchanger 120 by a heater 130. For example, the heater 130 may be a glow plug.

The second heat exchanger 128 may be located at a higher elevation than the first heat exchanger 120 such that a phase change of the fluid circulates the fluid between the first and second heat exchangers 120 and 128, respectively. When the second heat exchanger 128 is located at a higher elevation than the first heat exchanger 120, heated fluid rises from the first heat exchanger 120 to the second heat exchanger 128 and cooled fluid falls from the second heat exchanger 128 to the first heat exchanger 120. This may occur, for example, where the heated fluid rises from the first heat exchanger 120 as a vapor or gas and falls from the second heat exchanger 128 as a condensate.

A specific pressure in the fluid circuit at which the fluid is pressurized may be set as a function of a desired temperature at which the fluid will experience a phase change. Doing so sets the desired temperature as a threshold for when the fluid starts to flow and thus when the cells 106 will be cooled.

As one skilled in the art will understand, the first heat exchanger 120 may contact, and span, different end faces of the cells 106 than the end face 110. For example, the first heat exchanger 120 may be located below the cells 106 and contact, and span, bottom end faces 132 of the cells 106. Alternatively, the first heat exchanger 120 may contact multiple end faces of the cells 106. For example, the first heat exchanger 120 may cradle the cells 106 by contacting the end faces 110, the bottom end faces 132, and rear end faces 134, the rear end faces 134 being opposite the end faces 106. Or, the first heat exchanger 120 may contact, and span, the bottom end faces 132 and one of either the end faces 110 or the rear end faces 134 in an L-shape.

While certain embodiments of the present invention have been described in detail, those familiar with the art to which this invention relates will recognize various alternative designs and embodiments for practicing the invention as defined by the following claims.

1. A vehicle battery thermal system comprising:
a battery having cells arranged along an axis and having end faces parallel to the axis;
a sealed piping circuit including:
a first heat exchanger in contact with, and spanning, the end faces;
a second heat exchanger, spaced from the battery, in fluid communication with the first heat exchanger for heat transfer between the heat exchangers.

2. The system of claim 1 wherein a fluid is circulated through the circuit to absorb heat from the cells through the first heat exchanger and expel heat through the second heat exchanger, the second heat exchanger having cooling fins that use ambient air flow between the fins to cool the fluid.

3. The system of claim 2 wherein the second heat exchanger is located such that heated fluid rises from the first heat exchanger to the second heat exchanger and condensed fluid falls from the second heat exchanger to the first heat exchanger.

4. The system of claim 1 wherein the second heat exchanger is located such that heated fluid rises from the first heat exchanger to the second heat exchanger and condensed fluid falls from the second heat exchanger to the first heat exchanger.

5. The system of claim 1 wherein a phase change fluid is pressurized in the circuit and fluid phase changes circulate the fluid through the circuit.

6. The system of claim 1 further comprising a heater selectably supplying heat to the second heat exchanger, the circuit transferring the heat to the battery.

7. The system of claim 1 wherein the cells have first and second sides perpendicular to the faces and the first side of a first cell contacts the second side of a second cell.

8. A vehicle battery thermal system comprising:
a battery including cells having first and second faces perpendicular to cell end faces, the first face of a first cell contacting a second face of a second cell;
a sealed piping circuit including:
a first heat exchanger spanning one end face of each cell;
a second heat exchanger, spaced from the battery, in fluid communication with the first heat exchanger for heat transfer between the heat exchangers.

9. The system of claim 8 wherein a fluid is circulated through the circuit to absorb heat from the cells through the first heat exchanger and expel heat through the second heat exchanger, the second heat exchanger having cooling fins that use ambient air flow between the fins to cool the fluid.

10. The system of claim 9 wherein the second heat exchange is located such that heated fluid rises from the first heat exchanger to the second heat exchanger and condensed fluid falls from the second heat exchanger to the first heat exchanger.

11. The system of claim 8 wherein the second heat exchange is located such that heated fluid rises from the first heat exchanger to the second heat exchanger and condensed fluid falls from the second heat exchanger to the first heat exchanger.

12. The system of claim 8 wherein a phase change fluid is pressurized in the circuit, fluid phase changes circulate the fluid through the circuit, and the circuit is pressurized to control a temperature at which the fluid vaporizes.

13. The system of claim 8 further comprising a heater selectably supplying heat to the second heat exchanger, the circuit transferring the heat to the battery.

14. A method of thermally managing a vehicle battery comprising:
circulating a fluid through a first heat exchanger spanning one end face of each cell of a battery, each cell having first and second faces perpendicular to the end faces and the first face of a first cell contacting the second face of an adjacent cell;
exchanging heat between the first heat exchanger and the cells;
circulating the fluid through a circuit to transfer heat between the first and a second heat exchanger.

15. The method of claim 14 further comprising the step of circulating the fluid through the circuit to absorb heat from the cells by evaporating the fluid in the first heat exchanger and expelling heat by condensing the fluid in the second heat exchange, the second heat exchanger having cooling fins using ambient air flow between the fins to cool the fluid.

16. The method of claim 15 further comprising locating the second heat exchanger such that heated fluid rises from the first heat exchanger to the second heat exchanger and condensed fluid falls from the second heat exchanger to the first heat exchanger.

17. The method of claim 14 further comprising locating the second heat exchanger such that heated fluid rises from the first heat exchanger to the second heat exchanger and condensed fluid falls from the second heat exchanger to the first heat exchanger.

18. The method of claim 14 wherein the circuit is pressurized to control a temperature at which the fluid vaporizes.

19. The method of claim 14 further comprising selectably heating the second heat exchanger to transfer heat to the battery.
